(19) United States
(12) Patent Application Publication
(10) Pub. No.: US 2013/0205060 A1
(43) Pub. Date: Aug. 8, 2013

(54) PORTABLE ELECTRONIC DEVICE DOCKING STATION

(71) Applicant: Targus Group International, Inc., Anaheim, CA (US)

(72) Inventors: Ryan Gordon Benhard, Newport Beach, CA (US); Ron DeCamp, Westminster, CA (US)

(73) Assignee: TARGUS GROUP INTERNATIONAL, INC., Anaheim, CA (US)

(21) Appl. No.: 13/786,038

(22) Filed: Mar. 5, 2013

Related U.S. Application Data
(63) Continuation-in-part of application No. 13/365,754, filed on Feb. 3, 2012.

(51) Int. Cl. G06F 1/16

(52) U.S. Cl. CPC G06F 1/1632
USPC 710/303

(57) ABSTRACT

A docking station for a portable electronic device includes a body. The docking station includes a power receiving interface coupled to the body and configured to receive electrical power from a power supply. The docking station includes a universal data interface configured to communicatively couple the docking station with the portable electronic device. The docking station includes a power providing interface in electrical communication with the power receiving interface and configured to deliver electrical power to the portable electronic device.

### RELATED APPLICATIONS

This application claims priority under 35 U.S.C. §119(e) to U.S. patent application Ser. No. 13/365,754 filed Feb. 3, 2012 entitled “PORTABLE ELECTRONIC DEVICE DOCKING STATION” and to U.S. Provisional Patent Application No. 61/439,265, filed Feb. 3, 2011, entitled “PORTABLE ELECTRONIC DEVICE DOCKING SYSTEM,” both of which are herein incorporated by reference in their entirety.

### TECHNICAL FIELD

The present disclosure relates generally to portable electronic devices and, more specifically, to a universal docking station for a portable electronic device.

### BRIEF DESCRIPTION OF THE DRAWINGS

The written disclosure herein describes illustrative embodiments that are non-limiting and non-exhaustive. Reference is made to certain of such illustrative embodiments that are depicted in the figure(s), in which:

FIG. 1 illustrates a diagram of a universal docking station consistent with embodiments of the present disclosure.

FIG. 2 illustrates a diagram of a universal docking station communicatively coupled with accessory devices consistent with embodiments of the present disclosure.

FIG. 3 illustrates an isometric perspective view of a docking station consistent with embodiments of the present disclosure.

FIG. 4 illustrates a rear view of a docking station consistent with embodiments of the present disclosure.

FIG. 5 illustrates an isometric perspective view of a docking station with a wireless charging mat consistent with embodiments of the present disclosure.

FIG. 6 illustrates an isometric perspective view of a docking station with an internal wireless power coupler and internal wireless radio consistent with embodiments of the present disclosure.

FIG. 7A illustrates a schematic diagram of a docking station with a universal power interface and a universal data interface consistent with embodiments of the present disclosure.

FIG. 7B illustrates a schematic diagram of a docking station with a proprietary power interface and a universal data interface consistent with embodiments of the present disclosure.

FIG. 7C illustrates a schematic diagram of a docking station with a universal power interface and a universal data interface in a single interface consistent with embodiments of the present disclosure.

FIG. 7D illustrates a schematic diagram of a docking station with a proprietary power interface, a universal power interface, and a universal data interface consistent with embodiments of the present disclosure.

FIG. 7E illustrates a schematic diagram of a docking station with a wireless universal power interface and a wired universal data interface consistent with embodiments of the present disclosure.

FIG. 7F illustrates a schematic diagram of a docking station with a wired universal power interface and a wireless universal data interface consistent with embodiments of the present disclosure.

FIG. 7G illustrates a schematic diagram of a docking station with a wireless universal power interface and a wireless universal data interface consistent with embodiments of the present disclosure.

FIG. 7H illustrates a schematic diagram of a docking station with a wireless universal power interface and a wireless universal data interface in a single interface consistent with embodiments of the present disclosure.

### DETAILED DESCRIPTION

The proliferation of portable electronic devices (PEDs), including notebook computers (e.g., laptops, netbooks, ultrabooks, etc.), tablet computers (e.g., the Apple® iPad™ Amazon® Kindle™, etc.), portable digital assistants (PDAs), and smartphones, has placed more computing power into the hands of users than the computing power of early computers that occupied an entire room. Due to their portability, however, PEDs may not be ideally suited for sustained use over long periods of time. In some instances, PED interfaces may be designed primarily for portability rather than for functionality and ergonomic efficiency. For example, keyboard inputs and displays integrated in a PED (e.g., a laptop computer) may be sized significantly smaller than keyboard inputs and displays associated with a less-portable system (e.g., a desktop computer). Further, a PED designer may sacrifice integrating accessory devices in a PED such as, for example, multi-media drives, printers, joysticks, pointing inputs, and the like, for increased portability of the PED. In some situations, a PED may even have only a limited number or limited types of ports for interfacing with other devices.

To increase functionality and/or ergonomic efficiency during use over sustained periods, a PED may be coupled to a docking station capable of interfacing the PED with more functional and ergonomic inputs/outputs and/or displays. For example, a PED may connect to a docking station configured to interface the PED with a large discrete display (e.g., a 24″ computer monitor or the like), a full-sized ergonomic keyboard, and a pointing input (e.g., a computer mouse). These inputs/outputs and/or displays may then be used to control and/or interact with the PED.

Conventional docking stations include proprietary interfaces that allow the docking stations to only interface with PEDs manufactured by a particular entity and/or in the same product line. For example, a conventional docking station manufactured by Dell® may only be capable of interfacing with laptop computers manufactured by Dell®, and therefore may not be capable of interfacing with a laptop computer manufactured by Lenovo®. Similarly, a conventional docking station manufactured by Dell® for a certain product line of laptop computers may not be capable of interfacing with a laptop computer manufactured by Dell® in a different product line. Accordingly, a user may not readily switch between PED manufacturer and/or product lines without acquiring new docking stations capable of interfacing with new PEDs.

Embodiments of the present disclosure provide and describe a universal docking station for a PED. As used herein the term “universal” is given to mean usable by more than one platform. For example, a docking station, port, protocol, or interface that is used by a variety of brands of devices, a variety of types of devices, or for a variety of purposes may be referred to as a universal docking station, port, protocol, or interface. In certain embodiments, the universal docking station may utilize a single or multiple universal interface(s), tethered or untethered, to communicatively couple a PED to one or more inputs/outputs, displays, and/or accessory devices. In some embodiments, the universal interface may be a high-speed and/or super-speed universal data interface (e.g., Universal Serial Bus 3.0, SATA, eSATA, FireWire, DisplayPort™, Thunderbolt, Lightingbolt) or the like. In one embodiment, the universal data interface may include a Bluetooth, WiFi, WiDi, Tri-Band, NFC, WiFi Direct, AirPlay™, or other wireless radio technologies. In further embodiments, the universal docking station may be configured to provide electrical power to a PED. In certain embodiments, the universal docking station may be configured to provide electrical power to a PED via a single or multiple discrete interface(s) or single or multiple cable(s) integrated, tethered or untethered, with the universal interface. The electrical power may be provided in either a wired or wireless manner. For example, electrical power may be provided via a wire, cable, or other conduction point or may be provided via a radiating coil, antenna, or other wireless power coupling which induces or emits electromagnetic waves which can induce a flow of electricity in a corresponding receiving coil, antenna, or other wireless power coupling of a portable electronic device. One of skill in the art will recognize numerous methods for providing power or communicating without direct contact between devices.

By utilizing a universal data interface, the universal docking station may be utilized with any PED operable to communicate over the universal data interface regardless of the manufacturer of the PED. In certain embodiments, the universal docking station may be configured to provide electrical power to a PED via one or more discrete interfaces integrated, tethered or untethered, with a fixed or proprietary power interface. For example, a power interface may include a number of different types of power interfaces to accommodate different types of devices or power requirements. In some embodiments, by utilizing a fixed or propriety interface, the universal docking station may be utilized with a single, defined platform of PED devices while streamlining the user experience and minimizing additional parts. For example, a docking station designed for a specific platform of PED devices may be configured to more specifically meet the needs of that specific platform of devices.

Embodiments may be best understood by reference to the drawing(s), wherein like parts are designated by like numerals throughout. It will be readily understood that the components of the present disclosure, as generally described and illustrated in the drawing(s) herein, could be arranged and designed in a wide variety of different configurations. Thus, the following more detailed description of the embodiments of the systems, methods and apparatuses is not intended to limit the scope of the disclosure, but is merely representative of possible embodiments of the disclosure. In some cases, well-known structures, materials, or operations are not shown or described in detail.

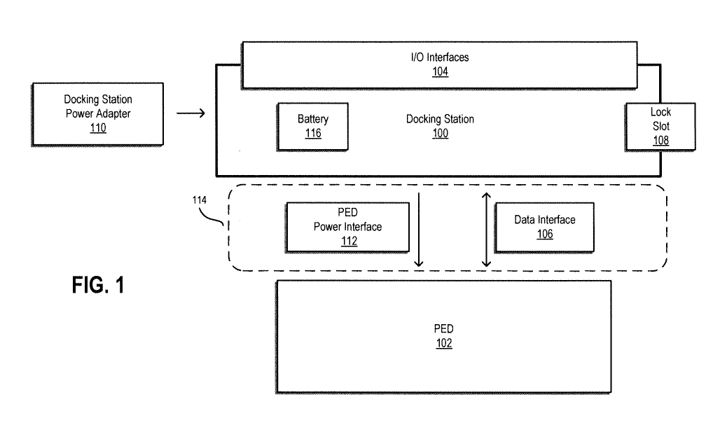

FIG. 1 illustrates a diagram of a universal docking station 100 for a PED 102 consistent with embodiments of the present disclosure. The docking station 100 may also be referred to as a hub, a port replicator, an expansion dock, and the like and, as used herein, does not necessarily imply a device which mechanically retains or secures the PED 102 on or within the docking station 100, although some embodiments of the docking station 100 may have such functionalities. The PED 102 may be any portable electronic device including, for example, a notebook computer (also referred to herein as a laptop computer), a netbook computer, an ultrabook computer, an electronic book reader (e.g., the Amazon® Kindle™), a smartphone (e.g., the Apple® iPhone™, the Motorola Droid®, and the BlackBerry Storm™), a tablet computer (e.g., the Apple® iPad™, the HP® Slate, and the Samsung® Galaxy™ Tablet), and/or a hybrid tablet/laptop (e.g. the ASUS® Transformer™ or other touch screen notebook with removable tablet).

In certain embodiments, the docking station 100 may include a body configured to receive a PED 102, and may further function to retain the PED 102 through a mechanical interface (e.g., a spring loaded mechanical clamp or the like). In other embodiments, the docking station 100 is not configured to physically receive a PED 102 but rather communicate with the PED 102 when it is in physical proximity to the docking station 100. For example, the docking station may be configured to interface with a PED 102 that is within range of a physical cable, a wireless power interface, and/or a wireless communication interface of the docking station 100. In such a case, a PED 102 may only need to be placed near to the docking station 100.

As shown, the docking station 100 may be configured to receive electrical power from a power adapter 110 configured to removably (i.e., untethered) or permanently (i.e., tethered) connect the docking station 100 to an electrical power supply. For example, the docking station 100 may require power from an external source or may have an internal battery 116 or other power source. For example, a docking station 100 with a battery 116 may be able to operate untethered, or unconnected, from an external power source. In one embodiment, the battery may provide power to a PED 102, accessory device, or other device even when the docking station 100 is not plugged in. The battery 116 as well as a compact and or convenient form factor may allow the docking station 100 to be portable. For example, the docking station 100 may be placed within a carrying bag with the PED 102 or other bag to be used conveniently in a variety of locations. In one embodiment, the docking station 100 may be removed from a bag for use or remain in a bag and provide docking or any other functionality as described herein. In other embodiments, the docking station 100 may not include the battery 116 and may be primarily designed for remaining at a location and allow convenient use when a PED 102 needs to be used at that location.

In some embodiments, the power adapter 110 may be configured to receive electrical power from a standard electrical utility socket (e.g., a 120V wall socket) and provide this power to the docking station 100. In certain embodiments, the power adapter 110 may include a transformer (not shown) and/or other power conditioning equipment configured to condition (e.g., step down) the electrical power provided to the docking station 100. In certain other embodiments, the power adapter 110 may provide unconditioned electrical power (e.g., not stepped-down) directly to the docking station 100, and the docking station 100 may include a transformer and/or other power conditioning equipment. In one embodiment, conditioning of the electrical power may be performed externally to a body of the docking station 100, for example in the power adapter 110. Electrical power provided to the docking station 100 by power adapter 110 may be provided to the PED 102 via a PED power interface 112. In one embodiment, the docking station 100 may condition the power received from the power adapter 110 for use by a PED 102.

As illustrated, the docking station 100 may include a lock slot or post 108 configured to allow a user to securely retain the docking station 100 to a secure object (e.g., a desk). In certain embodiments, the lock slot or post 108 may include a locking mechanism (not shown) configured to allow a user to selectively lock the docking station 100 to a secure object via a cable or the like. In certain other embodiments, the lock slot or post 108 may be configured to interface with a cable or the like that includes a locking mechanism separate from the docking station 100.

The PED 102 may be communicatively coupled with the docking station 100 via a data interface 106. The data interface 106 may be any type of wired or wireless data or communications interface. In some embodiments, the data interface 106 may be a standard non-proprietary interface that utilizes a widely available communication standard used by multiple PED 102 manufactures. For example, the data interface 106 may utilize standard or derivates of Universal Serial Bus (USB), IEEE 1394 (Firewire), Ethernet, eSata, HDMI, DVI, VGA, LightPeak™, CopperPeak™, ThunderBolt™, DisplayPort™, optical, telephone, and/or other similar communication standards. As further examples, the data interface 106 may utilize standard or derivatives of IEEE 802.11a, b, g, or n, (WiFi), Bluetooth, WiDi, Tri-Band, NFC, WiFi Direct, AirPlay™, or other wireless radio technologies.

The docking station 100 may include one or more input/output (I/O) accessory interfaces 104 configured to communicatively couple one or more accessory devices (not shown) to the docking station 100. For example, the I/O accessory interfaces 104 may be configured to communicatively couple one or more keyboards, pointer inputs (e.g., computer mice), disk drives, cameras, microphones, printers, scanners, speakers, music players, displays and the like to the docking station 100. In other embodiments, the data interface 106 is used to communicate with a PED and/or one or more accessory devices.

Accessory devices communicatively coupled to the docking station 100 via I/O accessory interfaces 104 or data interface 106 may communicate with the PED 102 via the data interface 106. In certain embodiments, the data interface 106 may be a high-speed, SuperSpeed, HyperSpeed, or the like data interface capable of communicatively coupling the PED 102 with one or more accessory devices via the I/O accessory interfaces 104 or the data interface 106 of the docking station 100. In some embodiments, the data interface 106 may utilize the USB 3.0 communication standard, allowing a connected PED 102 to output high-quality video to a single display or multiple displays (not shown) coupled to one of I/O accessory interfaces 104 and to receive input from one or more input devices (e.g., a pointer input, a keyboard, a joystick, and the like). Other high speed wireless interfaces may also be used. Further, the data interface 106 may allow a connected PED 102 to interface with communicatively coupled storage devices, printers, external hard drives, flash drives, scanners, digital cameras, digital video recorders, MP3 players, iPods, smartphones, and the like. In this manner, the docking station 100 may allow any PED 102 with an interface capable of utilizing the data interface 106 to communicate with one or more accessories communicatively coupled to the docking station 100. This functionality may allow the docking station 100 to be used by multiple PEDs 102 from different manufacturers and operating system platforms.

The PED power interface 112 is configured to provide power to a PED 102. The PED power interface 112 may be in electrical communication with the power receiving interface and may be configured to deliver electrical power to the PED 102. The PED power interface 112 may be a universal power interface that can be used by a variety of types of devices. For example, the PED power interface 112 may include a power tip that may be used to provide power to two or more platforms of devices. As another example, the PED power interface 112 may include a USB interface through which power may be provided to a PED 102 such as a smartphone, netbook, notebook or laptop, ultrabook, tablet computer, or any other like PED. Wireless power interfaces 112 may also be used. In one embodiment, the PED power interface 112 includes a primary wireless power coupling which is configured to wirelessly transmit power to a secondary wireless power coupling of a PED 102. The primary wireless power coupling of the PED power interface 112 and the secondary wireless power coupling of the PED 102 may be matched for size, resonance, or a variety of other factors to efficiently provide power to the PED 102. According to one embodiment, the PED power interface 112 may also provide power to one or more accessory devices. For example, USB accessories or accessories with secondary wireless power couplings to receive wireless power may also receive power from the PED power interface 112.

According to one embodiment, the PED power interface 112 is configured to provide power sufficient to power a smartphone. In other embodiments, the PED power interface 112 is configured to provide power substantially in excess of a power rating for a smartphone. For example, the PED power interface 112 may be configured to provide power sufficient for a notebook or laptop device. In one embodiment, the PED power interface 112 is configured to provide about 5 watts or more of power to a PED. In one embodiment, the PED power interface 112 provides power at any of the above levels through a USB cable, wirelessly, or through any other port, cable, or interface. According to one embodiment, the PED power interface 112 has different power limits depending on the type of PED the docking station 100 is designed for. For example, a docking station 100 designed for a smartphone, media player (such as an iPod® or any other MP3 player), or tablet computer may include a PED power interface 112 that is configured to provide about five watts of power or less. As another example, a docking station 100 designed for a laptop or notebook, netbook, ultrabook, or tablet computer may include a PED power interface 112 that is configured to provide about five watts of power or more.

As shown in FIG. 1, the PED power interface 112 and data interface 106 may be separate interfaces (e.g., utilize separate cables, or separate wireless interfaces). For example, the PED power interface 112 may use one cable, coil, or antenna while the data interface 106 uses another cable, coil, or antenna. In some embodiments, however, the functionality of the PED power interface 112 and data interface 106 may be embodied in a single interface 114 (e.g., utilize a single cable, coil or antenna) capable of providing both power to the PED 102 from the docking station 100 and communicatively coupling the PED 102 with the docking station 100. One embodiment, of a single interface 114 for both communicatively coupling and providing power to the PED 102 is a USB interface. Another embodiment of a single interface 114 for both communicatively coupling and providing power to the PED 102 is a Thunderbolt interface. In certain embodiments, the PED power interface 112 and data interface 106 may be separate interfaces that are physically bundled together for simplicity. In one embodiment, all of the data interface 106, PED power interface 112, and/or accessory I/O interface 104 may be included within the single interface 114.

In some embodiments, the docking station 100 may include a reset button (not shown) configured to reset the data interface 106 and/or one or more of I/O accessory interfaces 104. In certain embodiments, resetting the data interface 106 and/or one or more of I/O accessory interfaces 104 may be functionally equivalent to temporarily disconnecting then reconnecting the PED 102 from the data interface 106 and/or accessory devices from the I/O accessory interfaces 104. The docking station 100 may further include a power button (not shown) configured to control the power delivered to the PED 102 through the PED power interface 112. In certain embodiments, the power button may communicatively interface with the PED 102 to enable a controlled powerup, boot-up shutdown, power down, and/or hibernation of the PED 102 when the power button is pressed. Further, in some embodiments, the docking station 100 may be configured to store (e.g., bundle) other components and/or accessories used with the docking station 100 including, for example, cables associated with data interface 106, power tips associated with data interface 106, I/O accessory interfaces 104, PED power interface 112, and power adapter 110. In one embodiment, the docking station 100 may include a compartment to accommodate an accessory, such as a mouse or other accessory. For example, the mouse may be carried with the docking station 100 so that it may be used in conjunction with the docking station 100 and/or PED 102 at a destination.

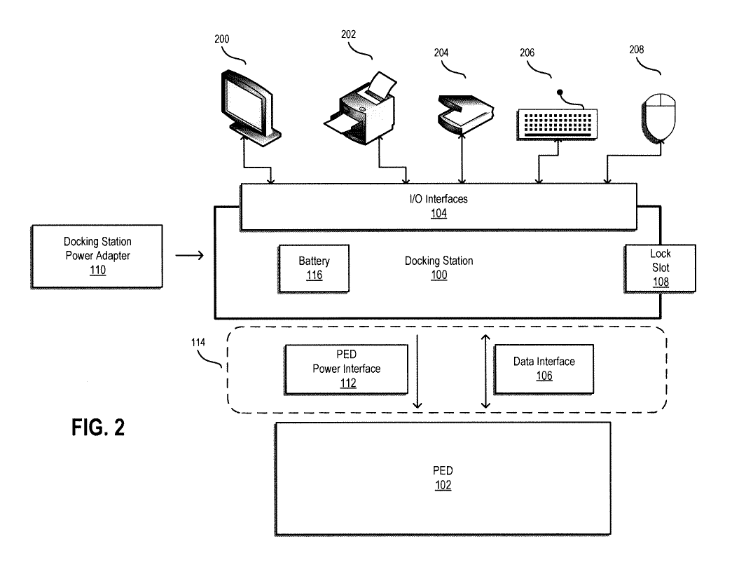

FIG. 2 illustrates a diagram of a universal docking station 100 communicatively coupled with accessory devices 200-208 consistent with embodiments of the present disclosure. The universal docking station 100 may be communicatively coupled with accessory devices 200-208 in a wired or wireless manner. As shown, the docking station 100 may be communicatively coupled via I/O accessory interfaces 104 with one or more accessory devices including but not limited to, for example, a display 200, a printer 202, a scanner, 204, a keyboard 206, and a pointer input 208. In turn, the PED 102 may be communicatively coupled with the docking station 100 via the data interface 106 which, in some embodiments, may be a high-speed, SuperSpeed, HyperSpeed, or the like data interface 106. Alternatively, both the accessory devices 200, 202, 204, 206, 208 and the PED 102 may be communicatively coupled with the docking station 100 via the data interface 106. The PED 102 may control and/or receive input from accessory devices 200-208 coupled to the docking station 100 via the data interface 106, the docking station 100, and/or I/O accessory interfaces 104. For example, the PED 102 may output high-quality video to the display(s) 200, while simultaneously outputting data to the printer 202 or receiving data from the scanner 204, the keyboard 206, and the pointer input 208.

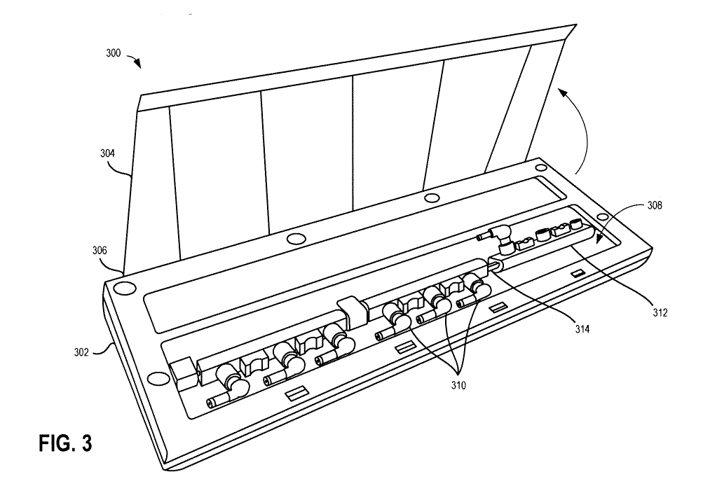

FIG. 3 illustrates an isometric perspective view of a docking station 300 consistent with embodiments of the present disclosure. The illustrated docking station 300 may incorporate certain features of the docking station 100 illustrated and described in reference to FIGS. 1-2, although all of such features may not be specifically illustrated in FIG. 3. The docking station 300 may include a main body 302 and a cover 304 pivotally connected along an edge of the main body 302 via a hinge 306, although other configurations of the main body 302, cover 304, and hinge 306 may be utilized. For example, in certain configurations, the main body 302, the cover 304, and/or the hinge 306 may be detachable. The main body 302 and cover 304 may comprise plastic, glass, metal, and/or any other suitable material.

In certain embodiments, the main body 302 may define one or more compartments 308. The one or more compartments 308 may be configured to store (e.g., bundle) one or more components used with the docking station 300. For example, the one or more compartments may be configured to store, house, and/or contain cables associated with any data interfaces, power tips 310 associated with power interfaces, tips associated with data interfaces, I/O accessory interfaces, PED power interfaces, and/or any power adapters, port adapters (e.g. HDMI to DVI or USB to micro USB), or other components used with the docking station 300. The cover 304 may be configured to cover and/or protect one or more components stored in the one or more compartments 308 when closed against the main body 302 about the hinge 306. In certain embodiments, the cover 304 may be configured to snap closed against the main body 302 about the hinge 306 using any suitable mechanical, magnetic, or other closure mechanism.

One or more accessory cradles or clips 312 configured to securely retain stored components may be included in the compartments 308 defined by the main body 302. For example, as illustrated, power tips 310 associated with power interfaces may be secured by the accessory cradles or clips 312 within the compartments 308. In certain embodiments, the accessory cradles or clips 312 may be configured to secure stored components via a compression mechanism, although any other method of mechanical securement may be utilized. In certain embodiments, the accessory cradles or clips 312 may be configured to pivot about a shaft 314 or other rotational mechanism or removable mechanism, thereby allowing the accessory cradle 312 to be rotated in and out of or removed from the compartments 308 and for easier access to any stored components secured therein.

According to one embodiment, the docking station 300 may be configured to communicatively couple to a PED via a wired connection and also provide power to the PED via a wired connection. According to another embodiment, the docking station 300 may be configured to wirelessly communicatively couple with a PED, for example via a wireless radio or other wireless communication device and provide power to the PED via a wired connection. According to another embodiment, the docking station 300 may be configured to communicatively couple to a PED via a wired connection and to wirelessly provide power to the PED. According to yet another embodiment, the docking station 300 may be configured to wirelessly communicatively couple to a PED and to wirelessly provide power to the PED.

The docking station 300 is shown without built in accessories. For example, the docking station 300 does not include a mouse, keyboard, monitor, or other input/output device for a PED. In one embodiment, the lack of accessories built into the docking station 300 allows for a lower cost of the dock and may also allow for more easily upgrading specific accessories. For example, a docking station 300 that includes a computer monitor may be expensive and may be upgraded at some point solely because a new monitor is needed or wanted and not because the functionality of the docking station 300 is otherwise out-of-date or damaged. Additionally, lack of built in accessories may also allow for a smaller and/or more convenient form factor that is conducive to portability of the docking station 300. For example, a docking station 300 with a built in monitor, keyboard, printer, etc. may be larger, heavier, and/or more difficult to carry.

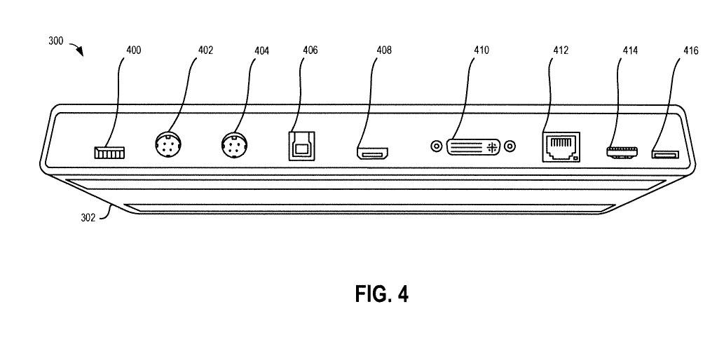

FIG. 4 illustrates a rear view of a docking station 300 consistent with embodiments of the present disclosure. The illustrated docking station 300 may incorporate certain features of the docking station 100 illustrated and described in reference to FIGS. 1-2, although all of such features may not be specifically illustrated in FIG. 4. As shown, the docking station 300 may include one or more I/O interfaces and/or data interfaces 406-416 and one or more PED power interfaces 400-404. Utilizing the illustrated interfaces 400-416, certain functionalities of the docking station 100 illustrated and described in reference to FIGS. 1-2, may be implemented.

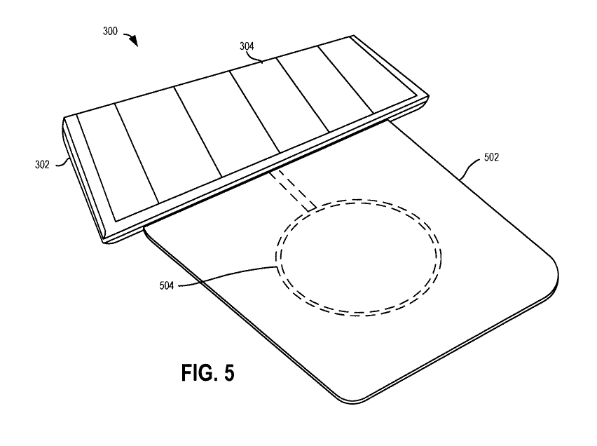

FIG. 5 illustrates an isometric perspective view of a docking station 300 with a wireless charging mat 502 consistent with embodiments of the present disclosure. The docking station 300 is shown with a main body 302 and cover 304 with a configuration similar to that in FIGS. 3-4. The cover 304 is shown in a closed position. A charging mat 502 extends from the main body 302 to lie flat on a surface. A primary coil 504 is depicted within the charging mat 502. In one embodiment, a current may be applied to the primary coil 504 using an internal power conditioner circuit. The primary coil 504 may induce electromagnetic waves which induce current flow in a secondary coil in a PED 102 or accessory (not shown). In one embodiment, the primary coil 504 is configured to match a specific type of secondary coil in size, resonance, or other property. The primary coil 504 and a secondary coil of a PED 102 are only exemplary wireless power couplings. Other wireless power couplings which do not necessarily include coils may be used in other exemplary embodiments.

In one embodiment, a PED 102, accessory, or other specific device is placed on or near the mat 502 in order to provide power to the specific device. For example, the secondary coil within a PED 102 may need to be aligned with the primary coil 504 to more efficiently provide power. In another embodiment, a PED 102, accessory, or other device is placed within a few feet of the primary coil 504 and still efficiently receives power. In one embodiment, primary coil 504 and a secondary coil are oriented similarly. For example, a PED 102 may be oriented such that a secondary coil in the PED 102 is horizontal like the primary coil 504.

In other embodiments, the primary coil 504 has a variety of sizes, locations, or orientations. Larger or smaller primary coils 504 may be used to match a size of a secondary coil. The primary coil 504 may be located in the main body 302, cover, or any other location. The primary coil 504 may be oriented vertically, horizontally, or at an angle. In one embodiment, a plurality of primary coils 504 of different sizes, orientations, and/or locations may be included with a docking station 300.

FIG. 6 illustrates an isometric perspective view of a docking station 300 with an internal primary coil 502 and radio 602. According to one embodiment, the internal primary coil 502 and/or radio 602 may allow for communicatively coupling and/or providing power to a PED in a wireless manner. According to one embodiment, cables or physical connectors may be included as well, as depicted in FIG. 3, to allow for use with PEDs not capable of wireless communication and/or wirelessly receiving power.

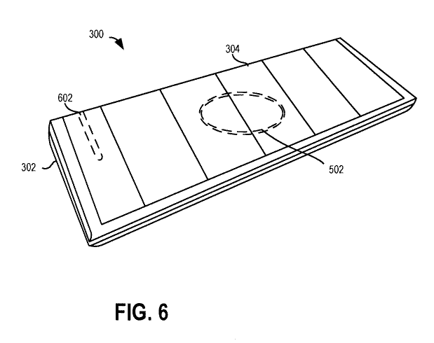

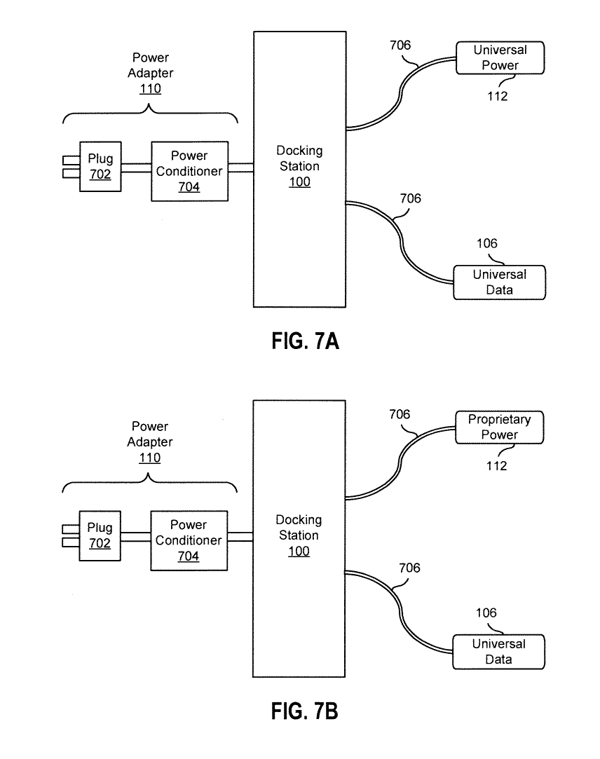

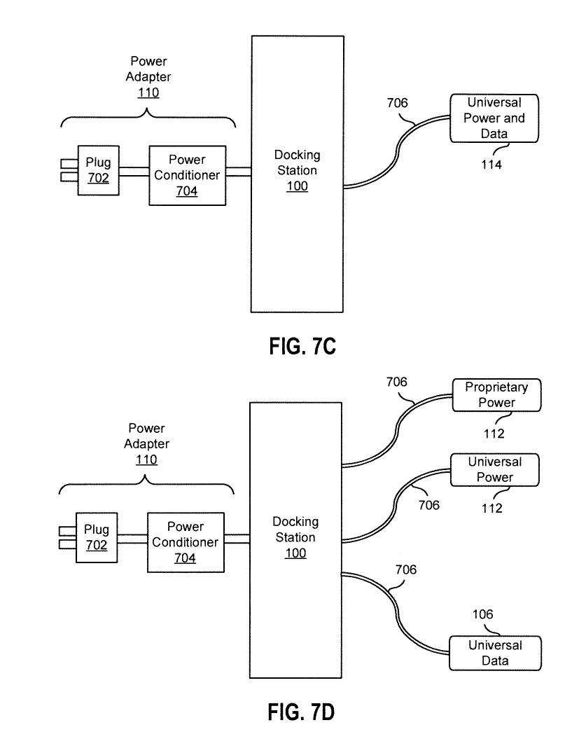

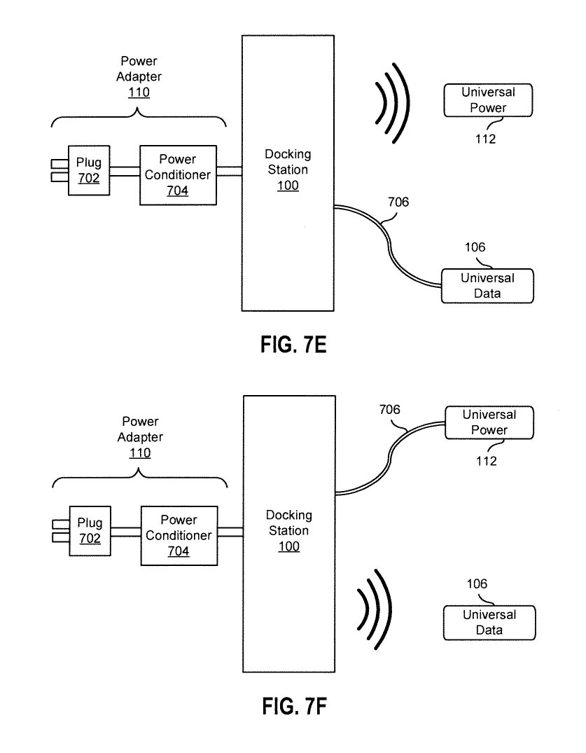

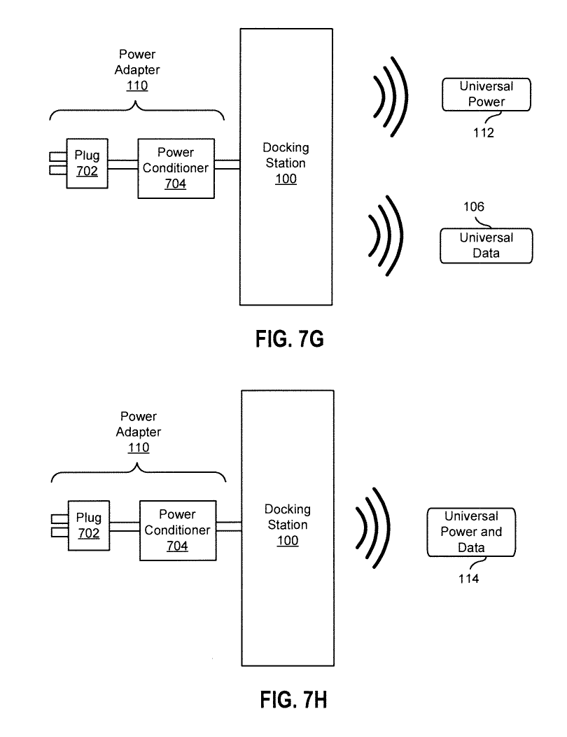

Turning now to FIGS. 7A-7H, variations of interfaces of a docking station 100 are illustrated. FIG. 7A is a schematic view of a docking station 100 with a power adapter 110, a data interface 106, and a power interface 112. In the depicted embodiment, the power adapter 110 includes a plug 702 for connecting to the grid or another power source and a power conditioner 704 to condition power received through the plug 102 for use by the docking station 100.

The data interface 106 and the power interface 112 are both universal interfaces and are connected via separate cables 706 to provide a wired connection between a PED and the docking station 100. According to one embodiment, one or more of the cables 706 are detachable from the docking station 100. For example, the cables 706 may plug into or unplug from ports on the docking station 100 and may be plugged into a port on another device or docking station. In another embodiment, the cables are fixedly attached to the docking station 100. Similarly, the data interface 106 and/or power interface 112 may include detachable or fixedly attached tips or port connectors. For example, the power interface 112 may include a detachable power tip that corresponds to one type of device or port and can be detached and/or replaced with a different power tip for another type of device or port.

FIG. 7B is a schematic view of a docking station 100 similar to FIG. 7A except that it includes a power interface 112 that is a proprietary interface. For example, the power interface 112 may be proprietary in that it uses a proprietary connector, or provides power to a PED in a proprietary manner. Once again, the cables 706 and/or any tips or port connectors may be detachable or fixedly attached.

FIG. 7C is a schematic view of a docking station 100 similar to FIG. 7A except that it includes a single interface 114 that provides both universal power and universal data. FIG. 7D is a schematic view of a docking station 100 with two power interfaces 112. The power interfaces 112 include a proprietary power interface and a universal power interface. Thus, the docking station 100 may be used to connect to devices requiring proprietary power and/or devices that may use universal power.

FIG. 7E is a schematic view of a docking station 100 with a wireless power interface 112 and a wired data interface 106. FIG. 7F is a schematic view of a docking station 100 with a wired power interface 112 and a wireless data interface 106. FIG. 7G is a schematic view of a docking station 100 with a wireless power interface 112 and a wireless data interface 106. FIG. 7H is a schematic view of a docking station 100 with a wireless single interface 114.

It will be understood by those having skill in the art that changes may be made to the details of the above-described embodiments without departing from the underlying principles presented herein. For example, any suitable combination of various embodiments, or the features thereof, is contemplated.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, inventive aspects lie in a combination of fewer than all features of any single foregoing disclosed embodiment. It will be apparent to those having skill in the art that changes may be made to the details of the above-described embodiments without departing from the underlying principles set forth herein.

What is claimed is:

1. A docking station for a portable electronic device comprising:
a body;
a power receiving interface coupled to the body and configured to receive electrical power from a power supply;
a universal data interface configured to wirelessly communicatively couple the docking station with the portable electronic device; and
a power providing interface in electrical communication with the power receiving interface and configured to deliver electrical power to the portable electronic device.

2. The docking station of claim 1, wherein the power providing interface is configured to wirelessly deliver electrical power to the portable electronic device.

3. The docking station of claim 1, further comprising an accessory interface configured to simultaneously communicatively couple the docking station with a plurality of accessory devices.

4. The docking station of claim 3, wherein the accessory interface comprises a wireless accessory interface to communicatively couple the docking station wirelessly with the plurality of accessory devices.

5. The docking station of claim 3, wherein the power providing interface is further configured to deliver electrical power wirelessly to one or more of the plurality of accessory devices.

6. The docking station of claim 1, wherein the universal data interface is configured to support a communication standard used by a plurality of manufacturers of portable electronic devices.

7. The docking station of claim 1, wherein the power providing interface is configured to provide power of about 5 watts or more of power to the portable electronic device.

8. The docking station of claim 7, wherein the portable electronic device comprises one or more of a laptop, a netbook, an ultrabook, a hybrid tablet/laptop, and a tablet computer.

9. The docking station of claim 1, wherein two or more of the universal data interface, the power providing interface, and an accessory interface are integrated into a single universal interface.

10. The docking station of claim 1, wherein docking station does not comprise an accessory.

11. The docking station of claim 10, wherein the docking station does not comprise a computer monitor.

12. The docking station of claim 1, wherein the docking station is portable.

13. The docking station of claim 1, wherein the docking station comprises a battery.

14. The docking station of claim 1, wherein the power receiving interface is configured to receive conditioned electrical power from the power supply, wherein the power supply is external to the body.

15. A docking station for a portable electronic device comprising:
a body;
a power receiving interface coupled to the body and configured to receive electrical power from a power supply;
an accessory interface configured to simultaneously communicatively couple the docking station with a plurality of accessory devices;
a universal data interface configured to wirelessly communicatively couple the docking station with the portable electronic device; and
a power providing interface in electrical communication with the power receiving interface and configured to deliver electrical power to the portable electronic device.

16. The docking station of claim 15, wherein two or more of the universal data interface, the power providing interface, and the accessory interface are integrated into a single universal interface.

17. The docking station of claim 15, wherein the power providing interface is configured to wirelessly deliver electrical power to the portable electronic device in the form of electromagnetic waves.

18. The docking station of claim 15, wherein the power providing interface comprises a primary coil configured to wirelessly provide electrical power to a secondary coil in a portable electronic device.

19. The docking station of claim 15, wherein the power providing interface is configured to provide power to the portable electronic device without direct contact between the power providing interface and the portable electronic device.

20. The docking station of claim 15, wherein the portable electronic device is a smartphone.

21. The docking station of claim 15, wherein the portable electronic device comprises one or more of a laptop, a netbook, an ultrabook, a hybrid tablet/laptop, and a tablet computer.

22. A docking station for a portable electronic device comprising:
a body configured to receive the portable electronic device;
a power receiving interface configured to receive electrical power from a power supply;
a plurality of accessory interfaces configured to communicatively couple the docking station with a plurality of accessory devices;
a universal data interface configured to wirelessly communicatively couple the docking station with the portable electronic device; and
a power providing interface configured to deliver electrical power to the portable electronic device.

23. The docking station of claim 22, wherein the body is further configured to mechanically retain the portable electronic device.

24. The docking station of claim 22, wherein the body is configured to store cables, the cables associated with one or more of:
an accessory interface of the plurality of accessory interfaces; and
the power receiving interface.

25. The docking station of claim 22, wherein the docking station is configured to store a plurality of power tips associated with one or more of the universal data interface, an accessory interface, the power providing interface, and the power receiving interface.

26. The docking station of claim 22, wherein the docking station includes a lock slot configured to secure the body to a secure object.

27. The docking station of claim 22, wherein the body is configured to store accessories associated with the portable electronic device.

28. The docking station of claim 22, wherein the universal data interface further comprises an interface selected from the group comprising: a high speed USB interface, an IEEE 1394 interface, a LightPeak™ interface, a CopperPeak™ interface, an Ethernet interface, an eSata interface, an HDMI interface, a DVI interface, a VGA interface, a ThunderBolt™ interface, and a Display Port interface.

29. A portable docking station for a portable electronic device comprising:
a body configured to receive the portable electronic device;
a battery;
a power receiving interface configured to receive electrical power from a power supply;
a plurality of accessory interfaces configured to communicatively couple the docking station with a plurality of accessory devices;
a universal data interface configured to wirelessly communicatively couple the docking station with the portable electronic device; and
a power providing interface configured to deliver electrical power to the portable electronic device.

30. The portable docking station of claim 29, wherein the power providing interface is configured to deliver electrical power to one or more of the portable electronic device and an accessory of the plurality of accessory devices when the portable docking station is not plugged in.
